(19) United States
(12) Patent Application Publication
(10) Pub. No.: US 2024/0007507 A1
(43) Pub. Date: Jan. 4, 2024

(54) DEVICE-SPECIFIC CONNECTIONS IN AN INFORMATION CENTRIC NETWORK

(71) Applicants: Yevgeni Koucheryavy, Tempere (FI); Intel Corporation, Santa Clara, CA (US)

(72) Inventors: Rustam Pirmagomedov, Oulu (FI); Srikathyayani Srikanteswara, Portland, OR (US); Felipe Andrés Tampier Jara, Espoo (FI); Gabriel Arrobo, Hillsboro, OR (US); Dmistri Moltchanov, Tampere (FI); Yi Zhang, Portlan, OR (US); Nageen Himayat, Fremont, CA (US); Sergey Andreev, Tampere (FI); Yevgeni Koucheryavy, Tempere (FI)

(21) Appl. No.: 18/030,237

(22) PCT Filed: Nov. 3, 2021
(86) PCT No.: PCT/US2021/057898

§ 371 Date: Apr. 4, 2023

Related U.S. Application Data
(60) Provisional application No. 63/109,187, filed on Nov. 3, 2020.

(51) Int. Cl. H04L 65/1069; H04L 65/613; H04L 45/745

(52) U.S. Cl. CPC H04L 65/1069; H04L 65/613; H04L 45/745

(57) ABSTRACT

System and techniques for device-specific connections in an information centric network (ICN) are described herein. A device is detected on a physical interface at an ICN node. A virtual interface is created for the device on the physical interface and the virtual device is added to a forward information base (FIB) entry. Then, when an interest packet with a name that corresponds to the device is received, the interest packet is forwarded to the device through the physical interface using the virtual interface based on the FIB entry.

### PRIORITY APPLICATION

This application claims priority to U.S. Provisional Application Ser. No. 63/109,187, filed Nov. 3, 2020, which is incorporated herein by reference it its entirety.

### TECHNICAL FIELD

Embodiments described herein generally relate to network interface operations and more specifically to device-specific connections in an information centric network (ICN).

### BACKGROUND

ICN is an umbrella term for a new networking paradigm in which information itself is named and requested from the network instead of hosts (e.g., machines that provide information). To get content, a device requests named content from the network itself. The content request may be called an interest and transmitted via an interest packet. As the interest packet traverses network devices (e.g., routers), a record of the interest is kept. When a device that has content matching the name in the interest is encountered, that device may send a data packet in response to the interest packet. Typically, the data packet is tracked back through the network to the source by following the traces of the interest left in the network devices.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an ICN device for device specific connections in an ICN, according to an embodiment.

FIG. 2A illustrates utilization of faces in a wired scenario, according to an embodiment.

FIG. 2B illustrates utilization of faces in a wireless scenario, according to an embodiment.

FIG. 3A illustrates a default face implementation for a wireless link, according to an embodiment.

FIG. 3B illustrates a modification to the default face implementation for Wi-Fi, according to an embodiment.

FIG. 4 illustrates virtual interfaces created for every neighbor device, according to an embodiment.

FIG. 5 illustrates changes in faces due to dynamism in the network, according to an embodiment.

FIG. 6 illustrates a workflow for named data networking (NDN) dynamic faces management, according to an embodiment.

FIG. 7 illustrates an example of a method for device specific connections in an ICN, according to an embodiment.

FIG. 8 is a block diagram illustrating an example of a machine upon which one or more embodiments may be implemented.

FIG. 9 illustrates an example ICN, according to an embodiment.

FIG. 10 illustrates operational layers among endpoints, an edge cloud, and cloud computing environments.

FIG. 11 illustrates an overview of an edge cloud configuration for edge computing.

FIG. 12 illustrates an example approach for networking and services in an edge computing system.

FIG. 13 illustrates an example software distribution platform to distribute software.

### DETAILED DESCRIPTION

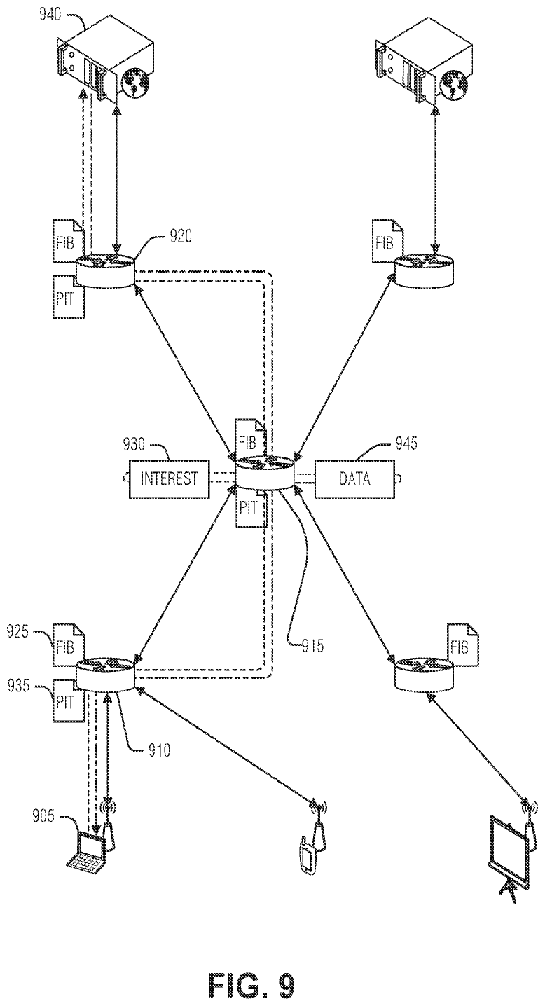

As noted above, in an ICN, access to the content is done through a pull-based model, where a client (e.g., a consumer) sends interest packets to the network requesting for a given content by its name and the network replies (sending data packets) with the content that was requested. FIG. 9 illustrates several ICN concepts. Central to these concepts are the use of named data, rather than device identifiers, to route packets. Thus, data is requested by name rather than making a request to a specific device as in address based networking such as in internet protocol (IP) networks. Named Data Networking (NDN) is a flavor of ICN that brings new opportunities for delivering better user experiences in scenarios that are challenging for current IP-based architectures. The NDN protocol uses a Named Data Networking Forwarding Daemon (NFD). The NFD includes a set of tools for routing and forwarding of interests, and for delivering data packets, using the same reverse path as interest packets.

When NFD selects an outgoing interface (e.g., face) for an interest packet, the NFD performs a lookup on the Forwarding Information Base (FIB). In contrast to IP networks, the NDN does not track node identifiers (IDs), such as IP addresses. Instead, forwarding relies on the interface names (e.g., face ID) to specify out which interface to send a packet for the next hop.

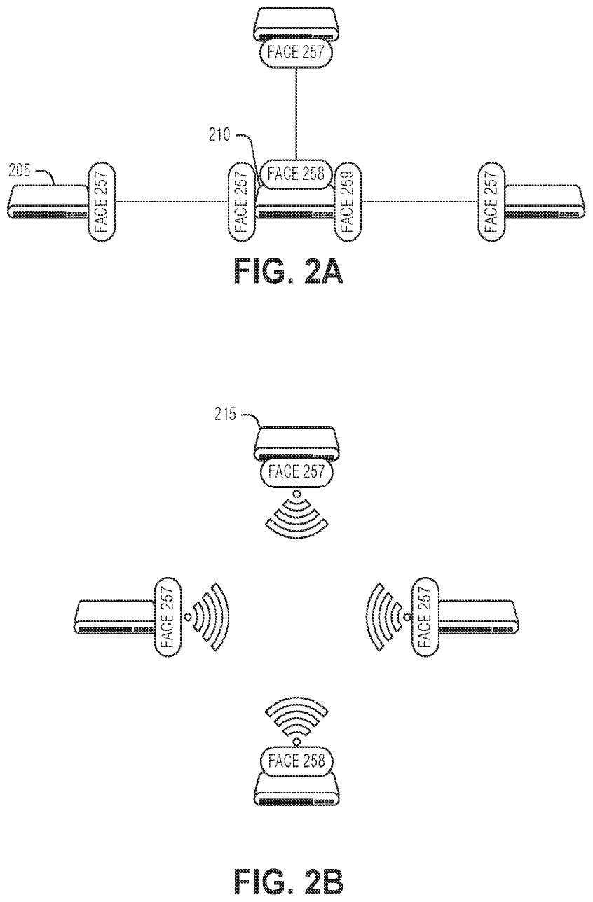

A face may serve as a physical network interface to communicate on a physical link, an overlay communication channel, or an inter-process communication channel between NFD and a local application. Considering wired communications, every connection with neighbor nodes uses a separate face, as illustrated in FIG. 2A. Such an approach allows the NFD to uniquely specify the path of an interest packet and avoid flooding because each face of a node in wired networks is commonly associated with only one neighbor device.

In wireless deployments (e.g., Wi-Fi or an IEEE 802.11 family of standards), the only one face is generally used to communicate over a physical layer as illustrated in FIG. 2B. If the face is configured for communication in unicast mode, then only one destination address is specified in the remoteUri attribute (e.g., field). To enable communication with multiple neighbor nodes, the face may be configured in broadcast mode, such that, for example, the face's destination address is ff:ff:ff:ff:ff:ff. Such an approach leads to several issues. For example, a node uses the same face for sending and receiving packets to any of its neighbors. Here, the face is not able to specify which of neighbor device is the intended destination. In some deployments (e.g., wireless mesh networks), this behavior may cause a broadcast storm, significantly increasing the number of packet collisions or overall communication overhead, such as when the same packet is rebroadcasted multiple times. The limited performance of broadcast mode in popular wireless protocols, is another issue that arises when using a wireless broadcast. For example, in broadcast mode, there may be no link-level acknowledgments, which may lead to unreliable operation of the system.

Some techniques to address these issues have been considered. For example, initial implementations of multi-connectivity scenarios, such as wireless mesh networks, may rely upon the broadcast communications. An ICN over a wireless network with mobile and stationary nodes communicating with each other in broadcast mode has been employed that did not use any solutions for dealing with broadcast storms. According to the implementers, ICN outperforms the conventional Transmission Control Protocol Internet Protocol (TCP/IP) architecture.

Several attempts have been made to handle the broadcast storms in wireless networks on higher layers. For example, in an NDN-based vehicular network that relies upon the broadcast mode, a mechanism was developed for limiting interest propagation in the network based on global positioning system (GPS) coordinates of the nodes and the special design of the namespace. Another technique that may be used includes limiting interest packet forwarding to several hops.

In an example, a timer-based technique may be used to mitigate broadcast flooding in ICN-based multi-hop wireless networks. In this technique, upon reception of an interest or a data packet, a timer for a random interval is set when a packet is received. The node then rebroadcasts the packet when the timer expires. If the node detects another node rebroadcasting the packet before the timer expires, the packet is discarded. This technique may also be used to reduce interest flooding that may occur in ICN vehicular networks. In an example, the timer calculation uses both a content connectivity score (e.g., interest satisfaction ratio) and a location score (e.g., if the current node is closer to the destination than the previous transmission node). The node with a higher score may get a shorter timer interval to rebroadcast the interest packet.

Some have tried to exploit ICN at the application level as an overlay to transmission control protocol (TCP)/IP transport. The use of TCP/IP enables unicast communications in mesh networks and similar scenarios by default. In an example, IP or MAC addresses may be used to identify the next hop for unicast communication.

A Dynamic Unicast (DU) approach has been proposed for Content Centric Network (CCNx) to avoid broadcast communication whenever possible. Hence, DU uses broadcast communication only until a content source has been found and then retrieves content directly via unicast from the same source.

These attempts to address the issues arising from face management in a wireless network are imperfect. Broadcast-based networking causes “a broadcast storm” in multi-hop networks. Although the broadcast storm in NDN is less severe than in TCP/IP networks, due to the default loop detection mechanism implemented in NFD, the negative effect on network performance is still significant. More specifically, nodes experience a high collision rate at the media access control (MAC) level, which is growing with a higher number of consumers, and with higher transmission rates. These collisions result in higher packet loss and latency.

The techniques tackling the broadcast issues via enhanced forwarding algorithms do not eliminate the overhead and collisions in the network. Moreover, the implementation of those techniques may be limited to specific use cases. For example, solutions based on external geographical information (e.g., GPS coordinates) generally cannot be used for scenarios when this information is not available (e.g., indoors). Furthermore, the imposed limit on the maximum number of hops induces a trade-off between the number of techniques used (e.g., overhead) and the reachability of requested data. Additionally, although timer-based techniques may help to reduce interest or data packet flooding, these techniques exhibit uncertainty on the success of packet forwarding because there is no feedback (e.g., acknowledgement) due to common broadcast operations. Also, due to the use of low order modulation and coding schemes in the broadcast regime by some wireless technologies, the provided channel capacity is lower than the one provided in a unicast communication mode.

Implementation of ICN features at the application level as a TCP/IP overlay eliminates the broadcast issues but brings notable processing overheads. Particularly, at each relay node, a packet needs to be decapsulated and delivered to the application layer, introducing additional delays and compromising energy efficiency.

To address the shortcomings of the techniques described above, a standard ICN node may provide unicast or multicast functionality on a shared medium, such as a wireless interface or a wired bus, by creating virtual interfaces for each remote device. The virtual interfaces may be used to designate recipient nodes, much like in a TCP/IP connection, without incurring the overhead in tunneling ICN over TCP/IP. Thus, default NFD functionality may be modified with virtual faces and a management technique. Here, multiple virtual faces may be created for a single wireless interface (e.g., cellular or Wi-Fi board). A virtual face may be dynamically created for every neighbor node that is in the wireless coverage area. When the neighbor node leaves the communications range, the associated face and corresponding prefixes reached via this face are removed from the local FIB and simultaneously stored in a separate structure for a certain time (e.g., a defined or set period of time, a predefined interval, etc.), called a quarantine time. If the connection is restored within the quarantine time, then the corresponding face with associated prefixes are also restored to the FIB.

This technique solves the issues of broadcast storms and unreliable communications present in current ICN networks run over wireless physical layers. This ensures a better user experience in a variety of use cases, such as wireless mesh networking or other multi-connectivity scenarios. These enhancements enable multi-hop communication, lead to higher reliability, lower latency, and more efficient utilization of a wireless channel. Additional details and examples are provided below.

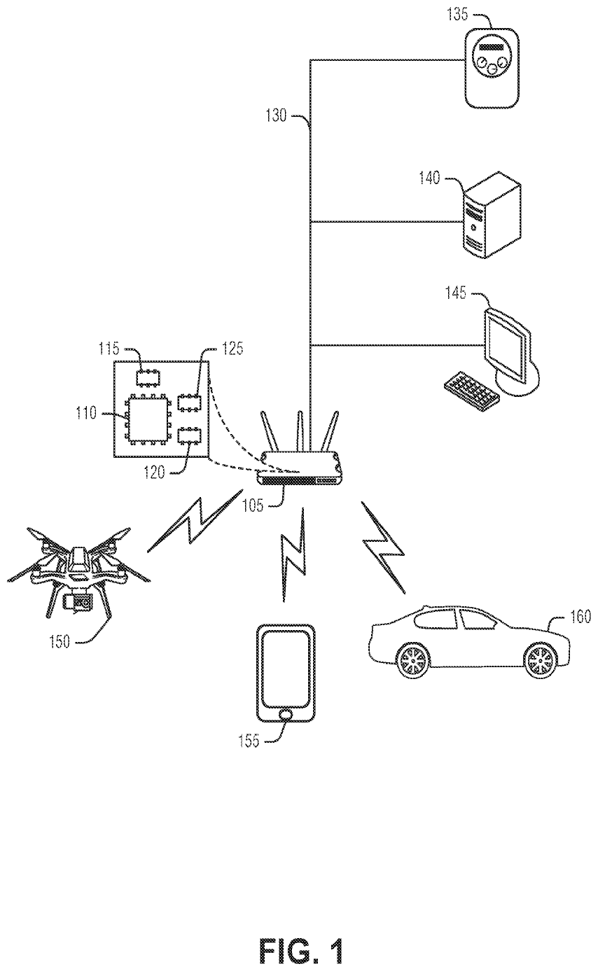

FIG. 1 illustrates an example of an ICN device 105 for device specific connections in an ICN, according to an embodiment. The ICN device 105 includes processing circuitry 110, a memory 115, and one or more physical interfaces, such as a wireless transceiver 120 or a network interface card (NIC) 125. As illustrated, the NIC 125 connects to a shared bus 130 upon which a personal computer 145, a server 140, and a utility meter 135 are connected. The wireless transceiver 120 provides wireless connectivity to a drone 150, a mobile device 155 (e.g., a smart phone, tablet, etc.), and a vehicle 160. These devices are merely illustrative of devices that may connect to the ICN device 105 via these two physical interfaces.

The memory 115 may store instructions that configure the processing circuitry 110, or data structures used in the operation of the ICN device 105. Examples of these data structures may include a pending interest table (PIT) or a forward information base (FIB). As explained with reference to FIG. 9, the PIT is sued to store an interface through which an interest packet was received and through which a corresponding data packet will be forwarded. The FIB maintains routing information for outbound interfaces through which the interest is forwarded.

The processing circuitry 110, when in operation, is configured (e.g., hardwired or by instructions in the memory 115) to detect a device on a physical interface. For example, the processing circuitry 110 may detect that the vehicle 160 device is available on the wireless transceiver 120 physical interface. Detection of the device may occur in any way that is available via the physical interface. For example, the processing circuitry 110 may receive an interrupt or other notification from the NIC 125 when the NIC 125 reads a new MAC address on the bus 130. In any case, the addition of a device is detected by the processing circuitry 110.

Once a device is detected, the processing circuitry 110 is configured to create a virtual interface (e.g., virtual face or vface) for the device on the physical interface. Here, a virtual interface appears like any other hardware interface to higher layers of the networking stack on the ICN device 105. Thus, without virtual interfaces, software running on the processing circuitry would detect two network interfaces, the wireless transceiver 120 and the NIC 125. However, with the addition of the virtual interface, the same software would detect three network interfaces. The virtual interface is tied to one of the physical interfaces, such as the wireless transceiver 120. Thus, if a transmission from a higher network layer is sent through the virtual interface, the wireless transceiver 120 would ultimately transmit the data. Creating a virtual interface for each device enables transmissions to be directed to the individual devices.

In an example, the virtual interface includes an identifier of the device. Identifiers may include serial numbers, MAC addresses, or the like. In shared media, such as the bus 130 or a wireless transmission, all devices may receive a transmission. However, the identifier may be used by the recipient devices to ignore transmissions not meant for them. Thus, a unicast or multicast capability is provided by the identifier over the shared medium. In an example, the identifier is a remote universal resource identifier (URI) of a transport layer to the physical interface. In an example, the remote URI is immutable for the virtual interface after the virtual interface is created. Here, once the virtual interface is created, it does not change. Accordingly, a new virtual interface is created for each device detected rather than reconfiguring a pool of virtual interfaces.

In an example, the virtual interface is one of multiple virtual interfaces. In an example, the multiple virtual interfaces include multiple types. Here, each type corresponds to a number of potential devices. Potential devices refer to the number of possible recipients. In an example, the types include unicast, broadcast, or multicast. Here, unicast specifies a possible single recipient, multicast specifies is more than one possible recipient and fewer than all possible recipients, and broadcast specifies all possible recipients. Thus, the specific type of recipient restrictions desired may be encapsulated in the virtual interface.

Once created, the virtual interface is added to a routing data structure for the ICN device 105. For example, the processing circuitry 110 is configured to add the virtual interface to the FIB or the PIT. In each case, an entry in the data structure is added with the virtual interface. As PIT entries are added upon receipt of an interest packet, the FIB may provide a stable store for the virtual interface if the virtual interface is not stored elsewhere (e.g., in a device configuration database or the like). Once added to the ICN routing data structures, the standard ICN routing techniques may be used without modification. Accordingly, the processing circuitry 110 may process an interest packet with a name that corresponds to the device that is received. In response, the processing circuitry 110 is configured to forward the interest packet to the device through the physical interface using the virtual interface based on the FIB entry. In an example, where the virtual interface includes an identifier of the device, forwarding the interest packet to the device through the physical interface using the virtual interface includes using the identifier in at least one of a physical layer, link layer, network layer, or transport layer for a protocol of the physical interface to unicast the interest packet to the device. Again, as noted above, the inclusion of the identifier enables the recipient device to discriminate between transmissions and only process or respond to those directed at that device.

In an example, the processing circuitry 110 is configured to process a packet received on the physical interface, the packet having a second identifier for a second device. The processing circuitry 110 may then search for the second identifier among virtual interfaces of the ICN node. If the search does not yield a match to any of the present virtual interfaces, the packet may be disposed of (e.g., dropped) in response. This sequence illustrates a noise reduction technique by dropping packets (or other transmissions) for which there has not been a virtual interface created for the transmitting device. In an example, such a transmission may be used to detect the presence of a device and initiate the creation of a new virtual interface.

Depending on how the virtual interfaces are implemented, the virtual interface may itself provide the search. Thus, in an example, searching for the second identifier among the virtual interfaces includes providing the packet to each virtual interfaces for the physical interface. Then, the second identifier may be matched to a local identifier by each virtual interface, each virtual interface refraining from processing the packet in response to the second identifier not matching the local identifier. Local identifier refers to the identifier of the device to which the virtual interface corresponds. Thus, a unicast virtual interface has a single local identifier for the device the virtual interface was created to serve, and a multicast virtual interface has two or more local identifiers. Broadcast interface does not have local identifiers, and thus may match nothing or everything depending upon its configuration.

In an example, when a device is no longer available for communication, such as the drone 150 flying out of range of the wireless transceiver 120, or the utility meter 135 being disconnected from the bus 130, the processing circuitry 110 is configured to disable the corresponding virtual interface. In an example, disabling the virtual interface includes deleting the virtual interface. In an example, disabling the virtual interface includes deleting entries in the PIT. FIB, or other data structure, that correspond to the virtual interface. The deletion of the virtual interface may be delayed to efficiently address reengagement of the device. Thus, the virtual interface definition may be stored in the memory 115 for a quarantine period. If the device is detected within that quarantine period, them the virtual device may be reused.

Using virtual interfaces to enable direct (e.g., unicast or multicast) communications to devices without changing the operation of an the ICN functionality in the ICN device 105 provides an efficient technique to avoid the issues of broadcast storms that may otherwise occur. This technique provides more robust communications through packet acknowledgment without the overhead of also using a TCP/IP, or similar, additional network protocol. Accordingly, the benefits of ICN communication are improved for networks over existing techniques.

FIG. 2A illustrates utilization of faces in a wired scenario, according to an embodiment. In NDN, the face may serve as a physical network interface to communicate on a physical link, an overlay communication channel, or an inter-process communication channel between NFD and a local application. Considering wired communications, every connection with neighbor nodes utilizes a separate face, as illustrated in FIG. 2A. Thus, node 205 has a single face 257 while node 210 has three faces: face 257, face 258, and face 259. Here, the face number refers to a local reference of the face rather than a universal reference. Such an approach allows the NFD to uniquely specify the path of an interest packet and avoid flooding because each face of a node in wired networks commonly associated with only one neighbor device. This is not true when the face connects to a bus, however, on which several devices may be attached. Such bus networks may include universal serial bus (USB) networks, controller area network (CAN) buses (often used in automobiles to enable communications between components installed in the automobile), or the like.

FIG. 2B illustrates utilization of faces in a wireless scenario, according to an embodiment. In wireless deployments (e.g., Wi-Fi or an IEEE 802.11 family of standards), the current version of NFD utilizes only one face to communicate over a physical layer as illustrated in FIG. 2B. Thus, the node 215 uses the one face 257 to communicate with the other illustrated nodes. If the face is configured for communication in unicast mode, then only one destination address can be specified in the remoteUri attribute (e.g., field). To enable communication with multiple neighbor nodes, the face is configured in broadcast mode, such that the face's destination address is ff:ff:ff:ff:ff:ff. Such an approach leads to several shortcomings. First, a node uses the same face for sending packets to any of its neighbors—as well as for receiving packets from any of those neighbors—and the face is not able to specify which of the neighbors is the intended destination. In some deployments (e.g., wireless mesh networks), this behavior may cause a broadcast storm, significantly increasing the number of packet collisions as well as overall communication overhead (e.g., when the same packet is rebroadcasted multiple times). Limited performance of broadcast mode in popular wireless protocols, such as Wi-Fi, is another issue present with using a wireless broadcast. For example, in broadcast mode, there are no link-level acknowledgments, which leads to the unreliable operation of the system, especially in heavy traffic conditions.

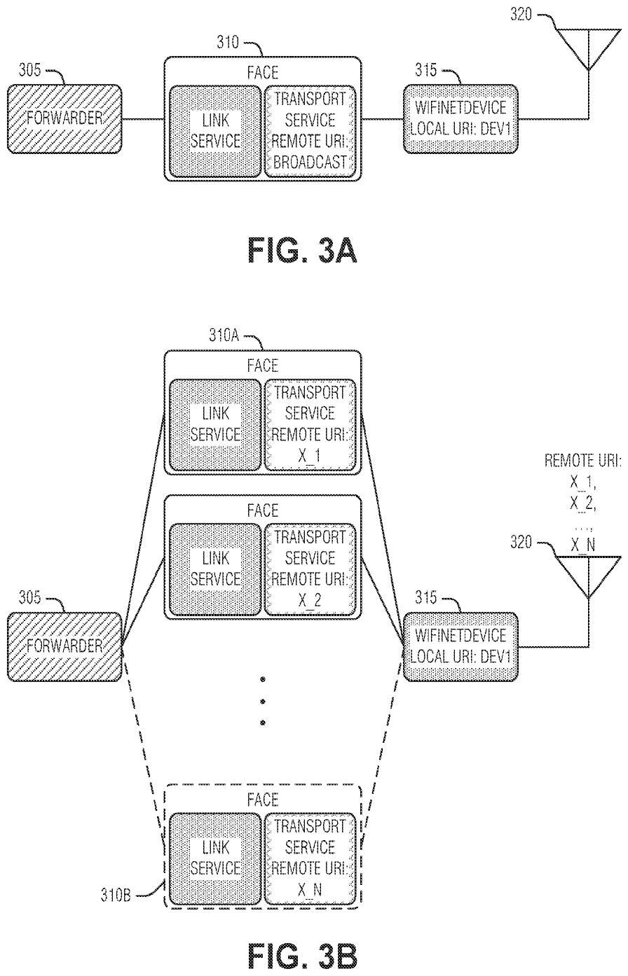

FIG. 3A illustrates a default face implementation for a wireless link, according to an embodiment. Here, faces are created by scanning network interfaces—called NetDevices (ND)—associated with the node and only one face is created for a single ND. Thus, the ND 315 is scanned to create the face 310, which is used by the forwarder 305 to transmit via the ND 315 and the antenna 320.

The face abstraction (nfd::face class) provides a best-effort delivery service for NDN network over the underlying communication mechanisms (e.g., sockets) and hides the specifics of the underlying protocols from the forwarding plane (e.g., the forwarder). As illustrated, the face 310 includes two main parts: 1) a link service; and 2) a transport service (e.g., NetDeviceTransport). Faces may be created through callbacks by going through each ND (e.g., Ethernet port, Wi-Fi board, etc.) of the node. Configuration of the transport service may include a remoteUri attribute that represents the remote endpoint of communication, such as the MAC address of the neighbor node. In an example, this remoteUri attribute is read-only and immutable during the face lifetime. In an example, the remoteUri is encoded such that it starts with a scheme (e.g., bit sequence) to indicate the underlying protocol (e.g., “ether” in case of using Ethernet on channel level), followed by a scheme-specific representation of the underlying address, such as ether://[01:00:5e:00:17:aa].

FIG. 3B illustrates a modification to the default face implementation for the wireless link, according to an embodiment. To reduce changes to the current NDN, increasing compatibility with existing NFD implementations, multiple virtual faces—such as virtual faces 310A through 310B—are enabled, or created, for the single ND 315. Additionally, the transport service used by virtual faces may be modified in a way that the transport service accepts packets only if their source address is the address contained in the transport service's own remoteUri. Because all faces are connected to the same ND 315, which forwards packets to all connected faces, it is up to the faces to determine whether or not to accept an incoming packet.

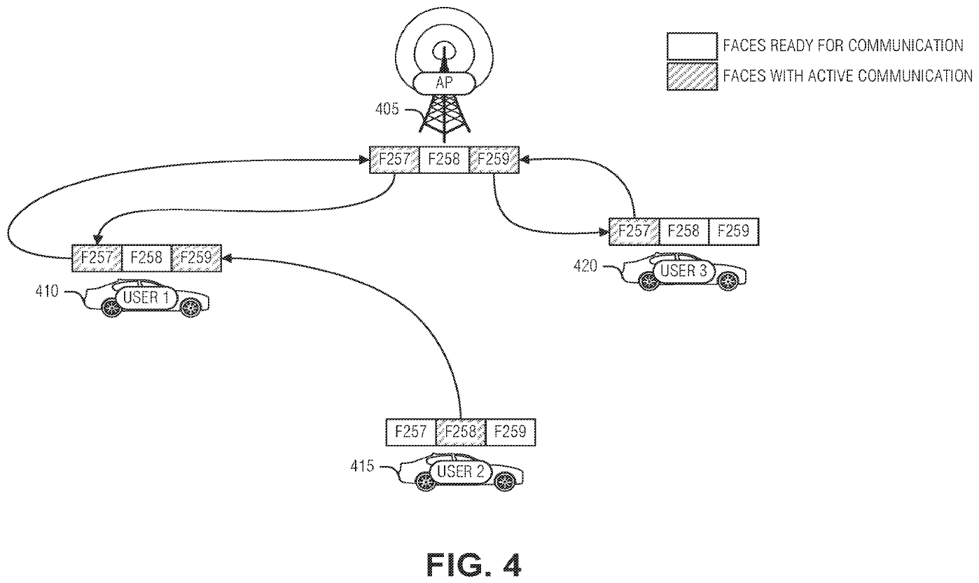

FIG. 4 illustrates virtual interfaces created for every neighbor device, according to an embodiment. As illustrated, an access point (AP) 405 is in wireless contact with the user one vehicle 410 and user three vehicle 420. The user 1 vehicle 410 is in contact with the user 2 vehicle 415. As with FIGS. 2A 2B, the face labels, e.g., F257 for the AP 405 are local face designations that do not impact the face designations at other nodes.

In wireless mobile deployments, connectivity among devices may change dynamically as a result of user mobility or link blockages (e.g., interference from terrain). Face management handles this dynamism by terminating and creating faces in real-time. For example, every wireless device creates a separate virtual face for every neighbor as illustrated. A virtual face may be configured to communicate with only one neighbor. For example, F257 of the user one vehicle 410 is configured to communicate with the AP 405, while F259 and F258 are configured for communication with the user two vehicle 420 and the user three vehicle 420 respectively.

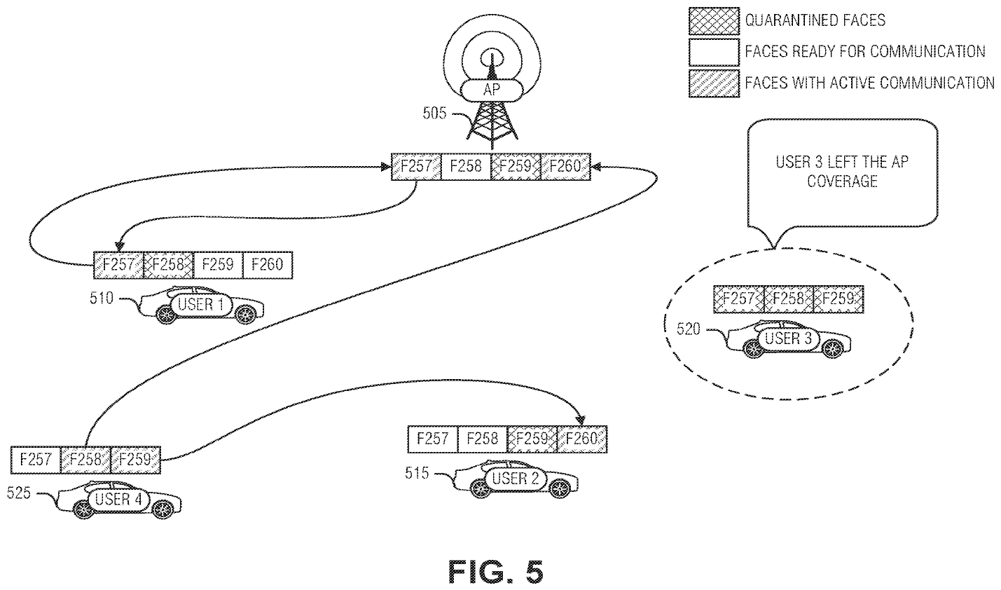

FIG. 5 illustrates changes in faces due to dynamism in the network, according to an embodiment. FIG. 5 illustrates the addition of the user 4 vehicle 525 and the removal of the user vehicle 520 from the situation illustrated in FIG. 4. The AP 505, the first user vehicle 510, and the second user vehicle 515 participate in the network with the AP 505 and the user four vehicle 525. Thus, when a new node comes into communication range, such as the user four vehicle 525, a face is added to enable unicast communications. When a link with a neighbor node is dropped—for example due to the user three vehicle 520 leaving the communication range—the node (e.g., an NDN pipeline on the node) deletes the associated face as well as related records from the PIT and FIB. However, the link may be dropped temporarily (e.g., because of blockages). In this case, information about namespaces available via that neighbor node (e.g., FIB entries) may be maintained for a predefined period of time and reinstated if the node comes back into contact before expiration of the predefined period of time. This may be called a quarantine for faces set to be removed. In an example, the quarantine procedure maintains FIB records corresponding to the quarantined face in case a link with a neighbor node is dropped temporarily (e.g., due to blockages in millimeter wave communications systems).

Prior to face deletion, the configuration details of the face, such as the remoteUri attribute, and related FIB entries are stored in a data structure called quarantine database (QDB). The entries in QDB are kept for a certain time regulated by a quarantine timer. The time of quarantine may vary depending on the deployment, but commonly is a minute or less. If the link with the node is restored, the FIB information from the appropriate QDB entry is copied back to the FIB, enabling immediate use of unicast forwarding.

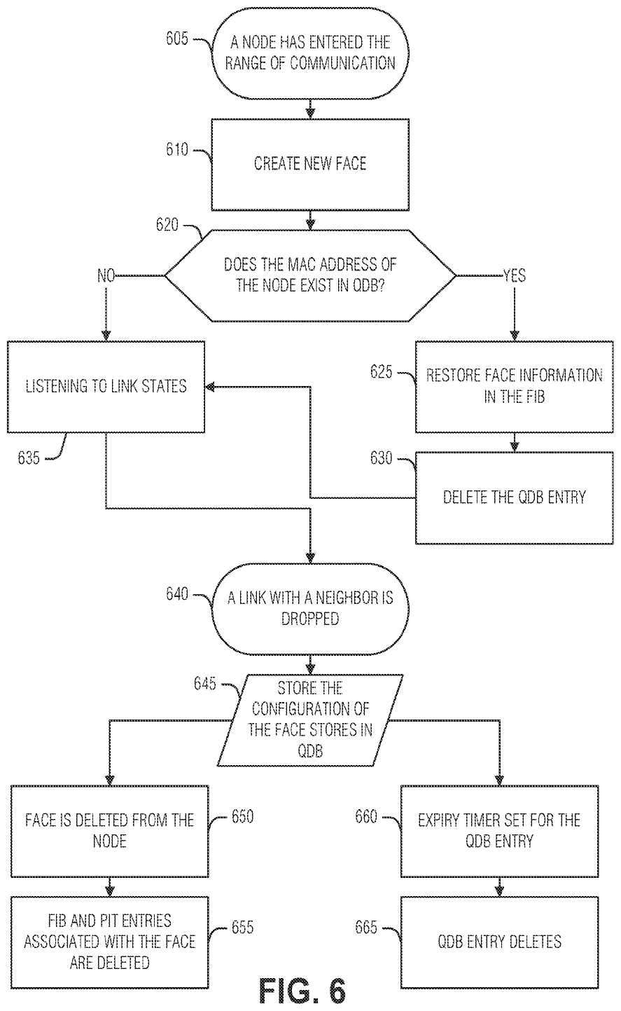

FIG. 6 illustrates a workflow for named data networking (NDN) dynamic faces management, according to an embodiment. In an example, the workflow uses continuous listening of the events on the communications (e.g., physical) channel.

At event 605, a face manager (e.g., a software or hardware component implemented by processing circuitry) is triggered when a new node comes into the coverage range.

At operation 610, the face manager creates a new face for communication with the new neighbor node.

At decision 620, a check is made to determine whether the MAC address of the arrived node matches a record in the QDB.

At operation 625, if the MAC address (e.g., as stored in the remoteUri attribute) of the arrived node matches a record in the QDB (decision 620), the corresponding information about reachable namespaces for the face are retrieved from the QDB and added to the FIB.

At operation 630, the matched record is removed from the QDB.

At operation 635, monitoring for changes on the channel is performed to identify whether a link is dropped.

At event 640, if a link with neighbor node drops, the channel level routine triggers the face manager.

At data 645, before deleting the face associated with a dropped link, the configuration of that face (including the remoteUri attribute) is stored in the QDB.

At operation 650, the face is deleted.

At operation 655, related FIB and PIT entries are deleted.

At operation 660, a quarantine timer is set for a record created in the QDB.

At operation 665, when the timer expires, the entry is removed from the QDB.

In an example, multiple virtual faces are created for a single ND and their dynamic management to enable targeted (e.g., unicast or multicast) communication with neighbor devices in a wireless environment. In an example, network-level point-to-point traffic in a broadcast environment is enabled. In an example, multi-hop communication in an NDN over a single wireless interface is enabled. In an example, load in the network caused by exploring resources—e.g., via temporal storing of the FIB entries related to the deleted faces—is reduced. In an example, reliability and throughput is increased when communicating over wireless—e.g., due to support of link-level acknowledgments, and higher data rates.

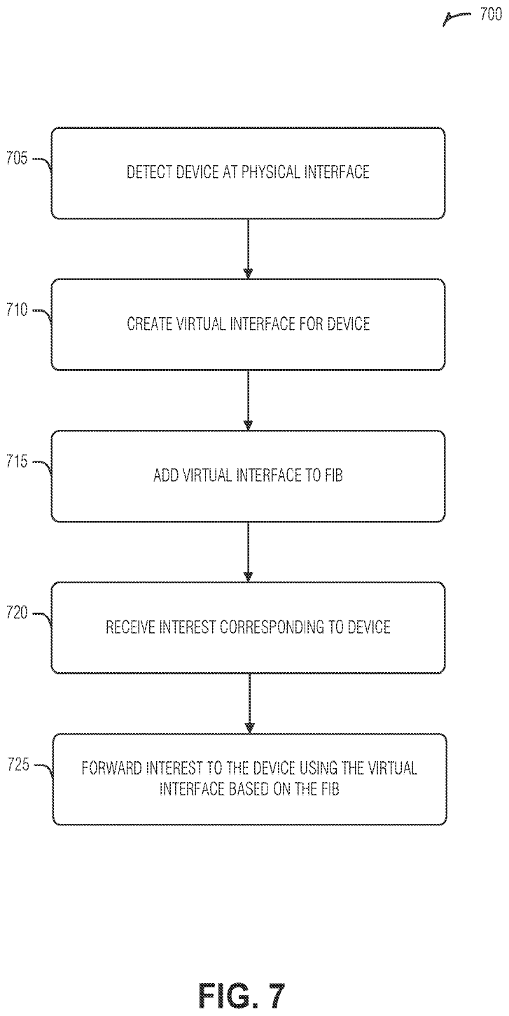

FIG. 7 illustrates an example of a method 700 for device specific connections in an ICN, according to an embodiment. The operations of the method 700 are performed by computational hardware, such as that described above (e.g., a device in an ICN node) or below (e.g., processing circuitry).

At operation 705, a device is detected on a physical interface. In an example, the physical interface is a wireless interface to a wireless protocol. In an example, the physical interface is a wired interface. In an example, the wired interface is to a bus.

At operation 710, a virtual interface is created for the device on the physical interface. In an example, the virtual interface includes an identifier of the device. In an example, the identifier is a remote universal resource identifier (URI) of a transport layer to the physical interface. In an example, the remote URI is immutable for the virtual interface after the virtual interface is created.

In an example, the virtual interface is one of multiple virtual interfaces. In an example, the multiple virtual interfaces include multiple types. Here, each type corresponds to a number of potential devices. In an example, the types include unicast, broadcast, or multicast. Here, multicast is to more than one device and fewer than all devices.

At operation 715, the virtual interface is added to a forward information base (FIB) entry.

At operation 720, an interest packet with a name that corresponds to the device is received.

At operation 725, the interest packet is forwarded to the device through the physical interface using the virtual interface based on the FIB entry. In an example, where the virtual interface includes an identifier of the device, forwarding the interest packet to the device through the physical interface using the virtual interface includes using the identifier in at least one of a physical layer, link layer, network layer, or transport layer for a protocol of the physical interface to unicast the interest packet to the device.

The operations above illustrate the successful forwarding of a packet to a device using the virtual interface. However, the virtual interfaces may also be used to reducing noise produced by other devices. Thus, in an example, the operations of the method 700 may include receiving a packet on the physical interface-here the packet includes a second identifier for a second device-searching for the second identifier among virtual interfaces of the ICN node, and disposing of the packet in response to failing to find the second identifier during the searching. In an example, searching for the second identifier among the virtual interfaces includes providing the packet to each virtual interfaces for the physical interface. Then, the second identifier may be matched to a local identifier by each virtual interface, each virtual interface refraining from processing the packet in response to the second identifier not matching the local identifier.

In an example, the method 700 may include the operations of detecting that the device is no longer available via the physical interface and disabling the virtual interface. In an example, disabling the virtual interface includes deleting the virtual interface. In an example, disabling the virtual interface includes deleting entries in a pending interest table that correspond to the virtual interface. In an example, disabling the virtual interface includes deleting the FIB entry.

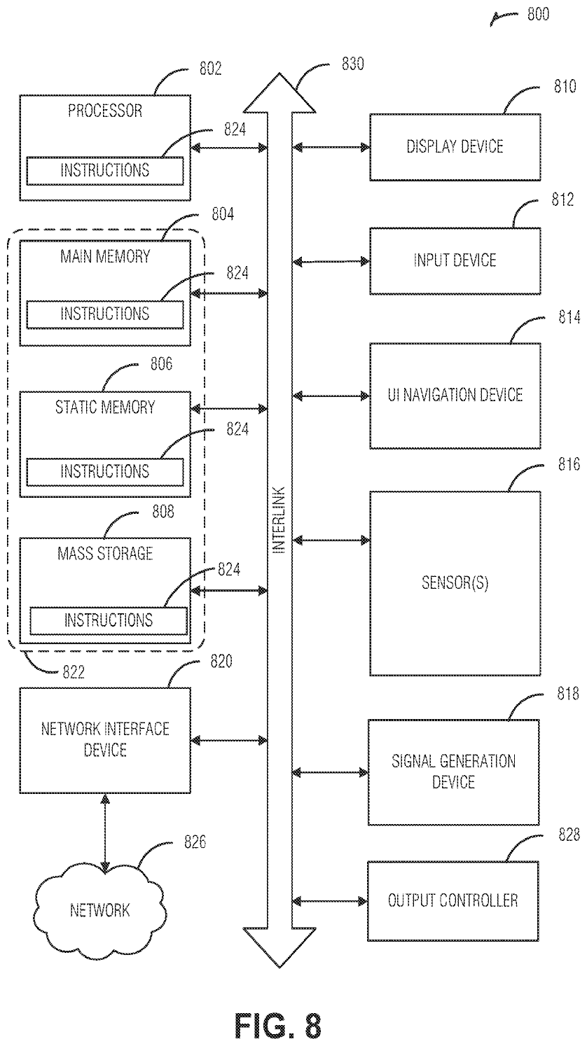

FIG. 8 illustrates a block diagram of an example machine 800 upon which any one or more of the techniques (e.g., methodologies) discussed herein may perform. Examples, as described herein, may include, or may operate by, logic or several components, or mechanisms in the machine 800. Circuitry (e.g., processing circuitry) is a collection of circuits implemented in tangible entities of the machine 800 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 800 follow.

In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, edge computing, software as a service (SaaS), other computer cluster configurations.

The machine (e.g., computer system) 800 may include a hardware processor 802 (e.g., a central processing unit (CPU), a graphics processing unit (GPU), a hardware processor core, or any combination thereof), a main memory 804, a static memory (e.g., memory or storage for firmware, microcode, a basic-input-output (BIOS), unified extensible firmware interface (UEFI), etc.) 806, and mass storage 808 (e.g., hard drive, tape drive, flash storage, or other block devices) some or all of which may communicate with each other via an interlink (e.g., bus) 830. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 808, a signal generation device 818 (e.g., a speaker), a network interface device 820, and one or more sensors 816, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 802, the main memory 804, the static memory 806, or the mass storage 808 may be, or include, a machine readable medium 822 on which is stored one or more sets of data structures or instructions 824 (e.g., software) embodying or utilized by any one or more of the techniques or functions described herein. The instructions 824 may also reside, completely or at least partially, within any of registers of the processor 802, the main memory 804, the static memory 806, or the mass storage 808 during execution thereof by the machine 800. In an example, one or any combination of the hardware processor 802, the main memory 804, the static memory 806, or the mass storage 808 may constitute the machine readable media 822. While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may be further transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks). Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software. A transmission medium is an example of a machine readable medium.

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

In an example, a machine-readable medium is, as opposed to a transitory propagating signal, one or more articles of manufacture-such as a device (e.g., circuit), material (e.g., a substrate), or combination of the two—that stores instructions for a machine (e.g., computer). These articles may be: located within the same housing, such as platters in a magnetic hard drive; in the same computer, such as in a magnetic hard drive and a solid-state flash drive in the same computer; or on different computers, such as various storage servers in a cloud. While the instructions embody directives for the machine, the instructions may take on variety of forms between storage and execution. For example, in an interpreted language, it is common that instructions take the form of source code on the machine readable medium but are transformed, by an interpreter, into object code or assembly prior to execution on target hardware, such as execution units in a processor. If the target hardware implements microcode, then even the assembly may be further transformed. In all cases however, the directive persists even though the form of the instruction may change. Examples of form changes for the instructions may include compilation, interpretation, linking, decoding, encoding, packaging, compression, or encryption.

An example of end-to-end instruction transformation in a storage-to-execution scenario may include instructions in the form of source code, modified source code (e.g., obfuscated, compressed, encrypted, transpiled, etc.), and object code placed in files or packages in a machine readable medium spread across a variety of storage locations, such as different storage devices in several data centers. A machine, such as a mobile phone, obtains (e.g., retrieves or receives) the instructions over an interface (e.g., a cellular network), which may be compressed or encrypted in transit, whereupon the files or packages may be decrypted, uncompressed, unpacked, combined, and modified prior to execution. Examples of instruction modification may include compilation of source code, interpretation of interpreted code, linking or assembly of object code, etc. Once the modification, if any, is complete, the instructions are executed on the machine.

FIG. 9 illustrates an example ICN, according to an embodiment. ICNs operate differently than traditional host-based (e.g., address-based) communication networks. ICN is an umbrella term for a networking paradigm in which information itself is named and requested from the network instead of hosts (e.g., machines that provide information). In a host-based networking paradigm, such as used in the Internet protocol (IP), a device locates a host and requests content from the host. The network understands how to route (e.g., direct) packets based on the address specified in the packet. In contrast, ICN does not include a request for a particular machine and does not use addresses. Instead, to get content, a device 905 (e.g., subscriber) requests named content from the network itself. The content request may be called an interest and transmitted via an interest packet 930. As the interest packet traverses network devices (e.g., network elements, routers, switches, hubs, etc.)—such as network elements 910, 915, and 920—a record of the interest is kept, for example, in a pending interest table (PIT) at each network element. Thus, network element 910 maintains an entry in its PIT 935 for the interest packet 930, network element 915 maintains the entry in its PIT, and network element 920 maintains the entry in its PIT.

When a device, such as publisher 940, that has content matching the name in the interest packet 930 is encountered, that device 940 may send a data packet 945 in response to the interest packet 930. Typically, the data packet 945 is tracked back through the network to the source (e.g., device 905) by following the traces of the interest packet 930 left in the network element PITs. Thus, the PIT 935 at each network element establishes a trail back to the subscriber 905 for the data packet 945 to follow.

Matching the named data in an ICN may follow several strategies. Generally, the data is named hierarchically, such as with a universal resource identifier (URI). For example, a video may be named www.somedomain.com or videos or v8675309. Here, the hierarchy may be seen as the publisher, “www.somedomain.com.” a sub-category, “videos,” and the canonical identification “v8675309.” As an interest 930 traverses the ICN. ICN network elements will generally attempt to match the name to a greatest degree. Thus, if an ICN element has a cached item or route for both “www.somedomain.com or videos” and “www.somedomain.com or videos or v8675309,” the ICN element will match the later for an interest packet 930 specifying “www.somedomain.com or videos or v8675309.” In an example, an expression may be used in matching by the ICN device. For example, the interest packet may specify “www.somedomain.com or videos or v8675*” where ‘*’ is a wildcard. Thus, any cached item or route that includes the data other than the wildcard will be matched.

Item matching involves matching the interest 930 to data cached in the ICN element. Thus, for example, if the data 945 named in the interest 930 is cached in network element 915, then the network element 915 will return the data 945 to the subscriber 905 via the network element 910. However, if the data 945 is not cached at network element 915, the network element 915 routes the interest 930 on (e.g., to network element 920). To facilitate routing, the network elements may use a forwarding information base 925 (FIB) to match named data to an interface (e.g., physical port) for the route. Thus, the FIB 925 operates much like a routing table on a traditional network device.

In an example, additional meta-data may be attached to the interest packet 930, the cached data, or the route (e.g., in the FIB 925), to provide an additional level of matching. For example, the data name may be specified as “www.somedomain.com or videos or v8675309.” but also include a version number—or timestamp, time range, endorsement, etc. In this example, the interest packet 930 may specify the desired name, the version number, or the version range. The matching may then locate routes or cached data matching the name and perform the additional comparison of meta-data or the like to arrive at an ultimate decision as to whether data or a route matches the interest packet 930 for respectively responding to the interest packet 930 with the data packet 945 or forwarding the interest packet 930.

ICN has advantages over host-based networking because the data segments are individually named. This enables aggressive caching throughout the network as a network element may provide a data packet 930 in response to an interest 930 as easily as an original author 940. Accordingly, it is less likely that the same segment of the network will transmit duplicates of the same data requested by different devices.

Fine grained encryption is another feature of many ICN networks. A typical data packet 945 includes a name for the data that matches the name in the interest packet 930. Further, the data packet 945 includes the requested data and may include additional information to filter similarly named data (e.g., by creation time, expiration time, version, etc.). To address malicious entities providing false information under the same name, the data packet 945 may also encrypt its contents with a publisher key or provide a cryptographic hash of the data and the name. Thus, knowing the key (e.g., from a certificate of an expected publisher 940) enables the recipient to ascertain whether the data is from that publisher 940. This technique also facilitates the aggressive caching of the data packets 945 throughout the network because each data packet 945 is self-contained and secure. In contrast, many host-based networks rely on encrypting a connection between two hosts to secure communications. This may increase latencies while connections are being established and prevents data caching by hiding the data from the network elements.

Example ICN networks include content centric networking (CCN), as specified in the Internet Engineering Task Force (IETF) draft specifications for CCNx 0.x and CCN 1.x, and named data networking (NDN), as specified in the NDN technical report DND-0001.

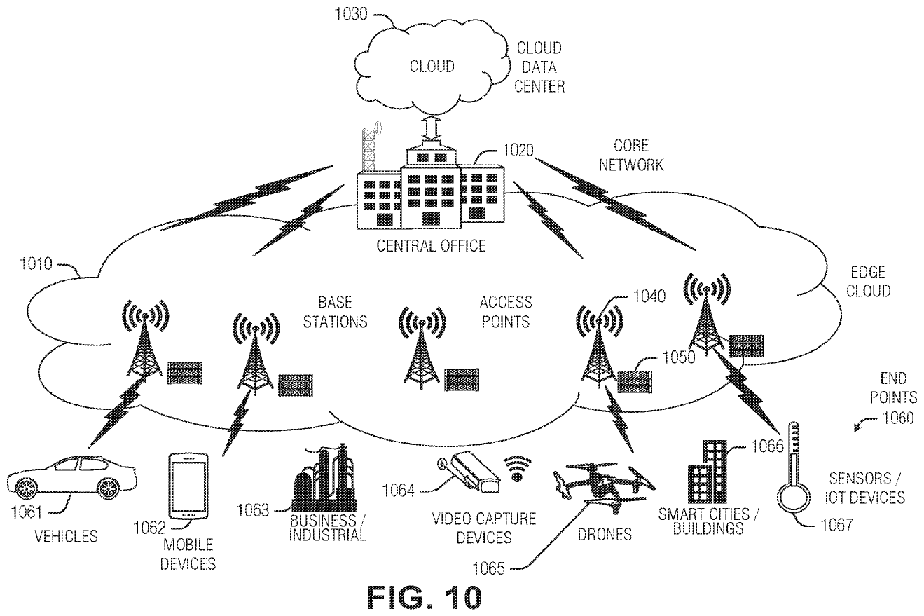

The following paragraphs provide a general overview of edge computing, as discussed or deployed with the ICN techniques herein. FIG. 10 is a block diagram 1000 showing an overview of a configuration for edge computing, which includes a layer of processing referred to in many of the following examples as an “edge cloud”. As shown, the edge cloud 1010 is co-located at an edge location, such as an access point or base station 1040, a local processing hub 1050, or a central office 1020, and thus may include multiple entities, devices, and equipment instances. The edge cloud 1010 is located much closer to the endpoint (consumer and producer) data sources 1060 (e.g., autonomous vehicles 1061, user equipment 1062, business and industrial equipment 1063, video capture devices 1064, drones 1065, smart cities and building devices 1066, sensors and IoT devices 1067, etc.) than the cloud data center 1030. Compute, memory, and storage resources which are offered at the edges in the edge cloud 1010 are critical to providing ultra-low latency response times for services and functions used by the endpoint data sources 1060 as well as reduce network backhaul traffic from the edge cloud 1010 toward cloud data center 1030 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

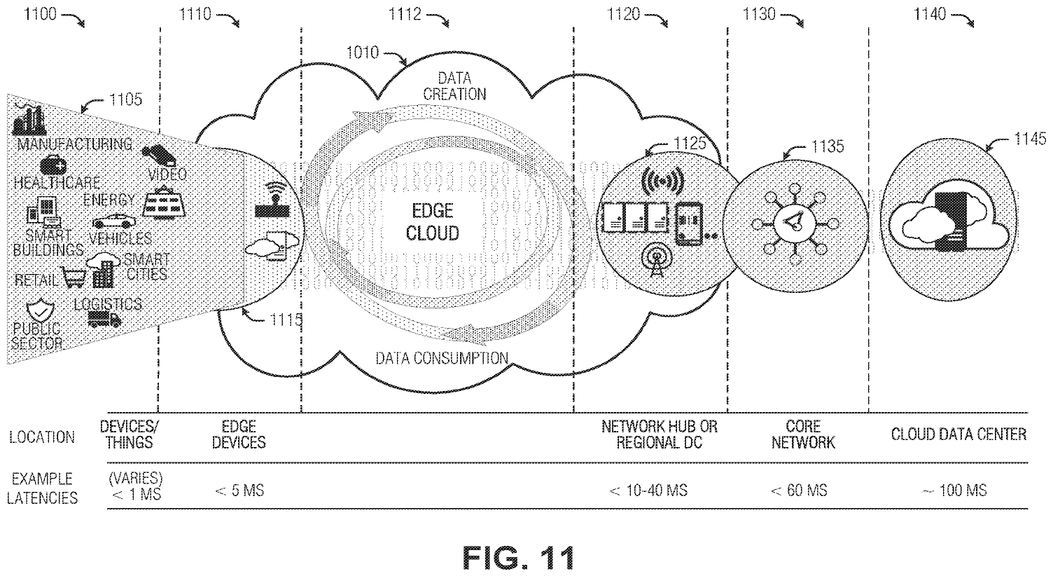

FIG. 11 illustrates operational layers among endpoints, an edge cloud, and cloud computing environments. Specifically. FIG. 11 depicts examples of computational use cases 1105, utilizing the edge cloud 1010 among multiple illustrative layers of network computing. The layers begin at an endpoint (devices and things) layer 1100, which accesses the edge cloud 1010 to conduct data creation, analysis, and data consumption activities. The edge cloud 1010 may span multiple network layers, such as an edge devices layer 1110 having gateways, on-premise servers, or network equipment (nodes 1115) located in physically proximate edge systems; a network access layer 1120, encompassing base stations, radio processing units, network hubs, regional data centers (DC), or local network equipment (equipment 1125); and any equipment, devices, or nodes located therebetween (in layer 1112, not illustrated in detail). The network communications within the edge cloud 1010 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1100, under 5 ms at the edge devices layer 1110, to even between 10 to 40 ms when communicating with nodes at the network access layer 1120. Beyond the edge cloud 1010 are core network 1130 and cloud data center 1140 layers, each with increasing latency (e.g., between 50-60 ms at the core network layer 1130, to 100 or more ms at the cloud data center layer). As a result, operations at a core network data center 1135 or a cloud data center 1145, with latencies of at least 50 to 100 ms or more, will not be able to accomplish many time-critical functions of the use cases 1105. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1135 or a cloud data center 1145, a central office or content data network may be considered as being located within a “near edge” layer (“near” to the cloud, having high latency values when communicating with the devices and endpoints of the use cases 1105), whereas an access point, base station, on-premise server, or network gateway may be considered as located within a “far edge” layer (“far” from the cloud, having low latency values when communicating with the devices and endpoints of the use cases 1105). It will be understood that other categorizations of a particular network layer as constituting a “close”, “local”. “near”, “middle”, or “far” edge may be based on latency, distance, number of network hops, or other measurable characteristics, as measured from a source in any of the network layers 1100-1140.

The various use cases 1105 may access resources under usage pressure from incoming streams, due to multiple services utilizing the edge cloud. To achieve results with low latency, the services executed within the edge cloud 1010 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 1010 may provide the ability to serve and respond to multiple applications of the use cases 1105 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 1010 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1010 (network layers 1100-1140), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1010.

As such, the edge cloud 1010 is formed from network components and functional features operated by and within edge gateway nodes, edge aggregation nodes, or other edge compute nodes among network layers 1110-1130. The edge cloud 1010 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1010 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 1010 may be servers, multi-tenant servers, appliance computing devices, and/or any other type of computing devices. For example, the edge cloud 1010 may be an appliance computing device that is a self-contained processing system including a housing, case or shell. In some cases, edge devices are devices presented in the network for a specific purpose (e.g., a traffic light), but that have processing or other capacities that may be harnessed for other purposes. Such edge devices may be independent from other networked devices and provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. The edge cloud 1010 may also include one or more servers and/or one or more multi-tenant servers. Such a server may implement a virtual computing environment such as a hypervisor for deploying virtual machines, an operating system that implements containers, etc. Such virtual computing environments provide an execution environment in which one or more applications may execute while being isolated from one or more other applications.

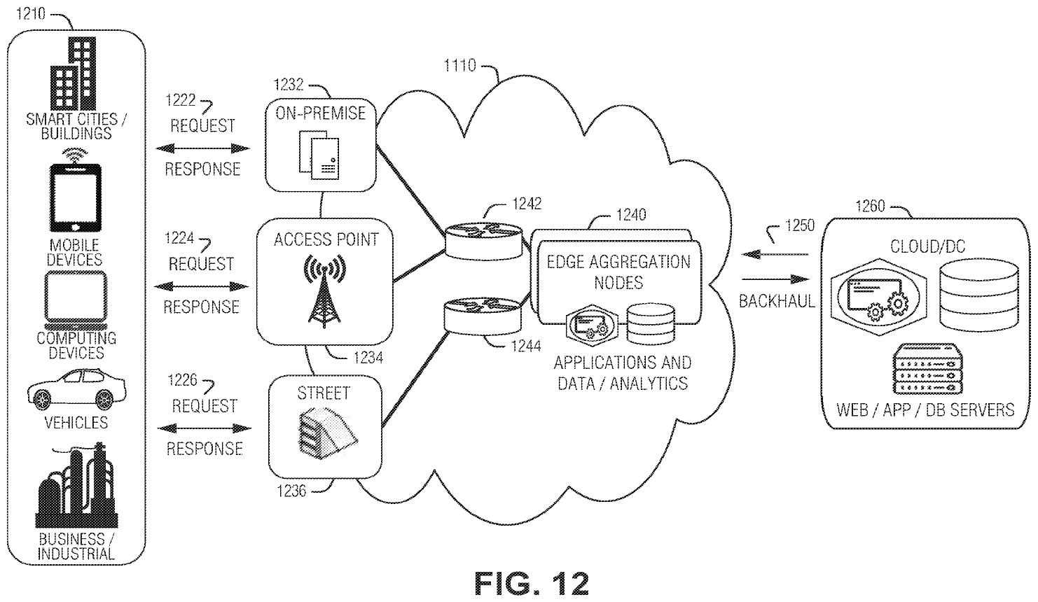

In FIG. 12, various client endpoints 1210 (in the form of mobile devices, computers, autonomous vehicles, business computing equipment, industrial processing equipment) exchange requests and responses that are specific to the type of endpoint network aggregation. For instance, client endpoints 1210 may obtain network access via a wired broadband network, by exchanging requests and responses 1222 through an on-premise network system 1232. Some client endpoints 1210, such as mobile computing devices, may obtain network access via a wireless broadband network, by exchanging requests and responses 1224 through an access point (e.g., cellular network tower) 1234. Some client endpoints 1210, such as autonomous vehicles may obtain network access for requests and responses 1226 via a wireless vehicular network through a street-located network system 1236. However, regardless of the type of network access, the TSP may deploy aggregation points 1242, 1244 within the edge cloud 1010 to aggregate traffic and requests. Thus, within the edge cloud 1010, the TSP may deploy various compute and storage resources, such as at edge aggregation nodes 1240, to provide requested content. The edge aggregation nodes 1240 and other systems of the edge cloud 1010 are connected to a cloud or data center 1260, which uses a backhaul network 1250 to fulfill higher-latency requests from a cloud/data center for websites, applications, database servers, etc. Additional or consolidated instances of the edge aggregation nodes 1240 and the aggregation points 1242, 1244, including those deployed on a single server framework, may also be present within the edge cloud 1010 or other areas of the TSP infrastructure.

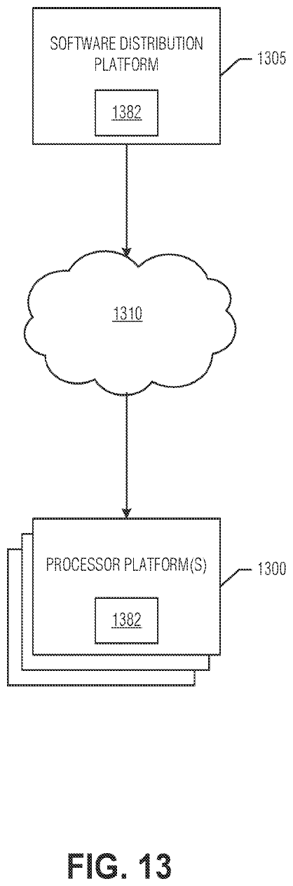

FIG. 13 illustrates an example software distribution platform 1305 to distribute software, such as the example computer readable instructions 1382 of FIG. 13, to one or more devices, such as example processor platform(s) 1300 or connected edge devices. The example software distribution platform 1305 may be implemented by any computer server, data facility, cloud service, etc., capable of storing and transmitting software to other computing devices (e.g., third parties, or connected edge devices). Example connected edge devices may be customers, clients, managing devices (e.g., servers), third parties (e.g., customers of an entity owning or operating the software distribution platform 1305). Example connected edge devices may operate in commercial or home automation environments. In some examples, a third party is a developer, a seller, or a licensor of software such as the example computer readable instructions 1382 of FIG. 13. The third parties may be consumers, users, retailers. OEMs, etc. that purchase or license the software for use or re-sale or sub-licensing. In some examples, distributed software causes display of one or more user interfaces (UIs) or graphical user interfaces (GUIs) to identify the one or more devices (e.g., connected edge devices) geographically or logically separated from each other (e.g., physically separated IoT devices chartered with the responsibility of water distribution control (e.g., pumps), electricity distribution control (e.g., relays), etc.).

In the illustrated example of FIG. 13, the software distribution platform 1305 includes one or more servers and one or more storage devices. The storage devices store the computer readable instructions 1382, which may correspond to the example computer readable instructions illustrated in the figures and described herein. The one or more servers of the example software distribution platform 1305 are in communication with a network 1310, which may correspond to any one or more of the Internet or any of the example networks described herein. In some examples, the one or more servers are responsive to requests to transmit the software to a requesting party as part of a commercial transaction. Payment for the delivery, sale or license of the software may be handled by the one or more servers of the software distribution platform or via a third-party payment entity. The servers enable purchasers or licensors to download the computer readable instructions 1382 from the software distribution platform 1305. For example, the software, which may correspond to the example computer readable instructions described herein, may be downloaded to the example processor platform(s) 1300 (e.g., example connected edge devices), which are to execute the computer readable instructions 1382 to implement the technique. In some examples, one or more servers of the software distribution platform 1305 are communicatively connected to one or more security domains or security devices through which requests and transmissions of the example computer readable instructions 1382 must pass. In some examples, one or more servers of the software distribution platform 1305 periodically offer, transmit, or force updates to the software (e.g., the example computer readable instructions 1382 of FIG. 13) to ensure improvements, patches, updates, etc. are distributed and applied to the software at the end user devices.

In the illustrated example of FIG. 13, the computer readable instructions 1382 are stored on storage devices of the software distribution platform 1305 in a particular format. A format of computer readable instructions includes, but is not limited to a particular code language (e.g., Java, JavaScript. Python. C, C #. SQL, HTML, etc.), or a particular code state (e.g., uncompiled code (e.g., ASCII), interpreted code, linked code, executable code (e.g., a binary), etc.). In some examples, the computer readable instructions 1382 stored in the software distribution platform 1305 are in a first format when transmitted to the example processor platform(s) 1300. In some examples, the first format is an executable binary in which particular types of the processor platform(s) 1300 can execute. However, in some examples, the first format is uncompiled code that requires one or more preparation tasks to transform the first format to a second format to enable execution on the example processor platform(s) 1300. For instance, the receiving processor platform(s) 1300 may need to compile the computer readable instructions 1382 in the first format to generate executable code in a second format that is capable of being executed on the processor platform(s) 1300. In still other examples, the first format is interpreted code that, upon reaching the processor platform(s) 1300, is interpreted by an interpreter to facilitate execution of instructions.

### Additional Notes & Examples

Example 1 is an apparatus for device-specific connections in an information centric network (ICN), the apparatus comprising: a connection to a physical interface; a memory including instructions; processing circuitry that, when in operation, is configured by the instructions to: detect, via the connection to the physical interface, a device on the physical interface; create a virtual interface for the device on the physical interface; add the virtual interface to a forward information base (FIB) entry; receive an interest packet with a name that corresponds to the device; and forward the interest packet to the device through the physical interface using the virtual interface based on the FIB entry, wherein the apparatus is included in an ICN node.

In Example 2, the subject matter of Example 1, wherein the virtual interface includes an identifier of the device.

In Example 3, the subject matter of Example 2, wherein, to forward the interest packet to the device through the physical interface using the virtual interface, the processing circuitry uses the identifier in at least one of a physical layer, link layer, network layer, or transport layer for a protocol of the physical interface to unicast the interest packet to the device.

In Example 4, the subject matter of Example 3, wherein the identifier is a remote universal resource identifier (URI) of a transport layer to the physical interface.

In Example 5, the subject matter of Example 4, wherein the remote URI is immutable for the virtual interface after the virtual interface is created.

In Example 6, the subject matter of any of Examples 1-5, wherein the physical interface is a wired interface.

In Example 7, the subject matter of Example 6, wherein the wired interface is to a bus.

In Example 8, the subject matter of any of Examples 1-7, wherein the physical interface is a wireless interface to a wireless protocol.

In Example 9, the subject matter of any of Examples 2-8, wherein the instructions configure the processing circuitry to: receive a packet on the physical interface, the packet including a second identifier for a second device; search for the second identifier among virtual interfaces of the ICN node; and dispose of the packet in response to failing to find the second identifier during the searching for the second identifier among the virtual interfaces.

In Example 10, the subject matter of Example 9, wherein, to search for the second identifier among the virtual interfaces, the processing circuitry is configured by the instructions to: provide the packet to each virtual interfaces for the physical interface; and match the second identifier to a local identifier by each virtual interface, each virtual interface refraining from processing the packet in response to the second identifier not matching the local identifier.

In Example 11, the subject matter of any of Examples 1-10, wherein the instructions configure the processing circuitry to: detect that the device is no longer available via the physical interface; and disable the virtual interface.

In Example 12, the subject matter of Example 11, wherein, to disable the virtual interface, the processing circuitry deletes the virtual interface.

In Example 13, the subject matter of Example 12, wherein, to disable the virtual interface, the processing circuitry deletes entries in a pending interest table that correspond to the virtual interface.

In Example 14, the subject matter of any of Examples 12-13, wherein, to disable the virtual interface, the processing circuitry deletes the FIB entry.

In Example 15, the subject matter of any of Examples 1-14, wherein the virtual interface is one of multiple virtual interfaces.

In Example 16, the subject matter of Example 15, wherein the multiple virtual interfaces include multiple types, each type corresponding to a number of potential devices.

In Example 17, the subject matter of Example 16, wherein the multiple types include unicast, broadcast, or multicast, wherein multicast is to more than one device and fewer than all devices.

Example 18 is a method for device-specific connections in an information centric network (ICN), the method comprising: detecting, at an ICN node, a device on a physical interface; creating a virtual interface for the device on the physical interface; adding the virtual interface to a forward information base (FIB) entry; receiving an interest packet with a name that corresponds to the device; and forwarding the interest packet to the device through the physical interface using the virtual interface based on the FIB entry.

In Example 19, the subject matter of Example 18, wherein the virtual interface includes an identifier of the device.

In Example 20, the subject matter of Example 19, wherein forwarding the interest packet to the device through the physical interface using the virtual interface includes using the identifier in at least one of a physical layer, link layer, network layer, or transport layer for a protocol of the physical interface to unicast the interest packet to the device.

In Example 21, the subject matter of Example 20, wherein the identifier is a remote universal resource identifier (URI) of a transport layer to the physical interface.

In Example 22, the subject matter of Example 21, wherein the remote URI is immutable for the virtual interface after the virtual interface is created.

In Example 23, the subject matter of any of Examples 18-22, wherein the physical interface is a wired interface.

In Example 24, the subject matter of Example 23, wherein the wired interface is to a bus.

In Example 25, the subject matter of any of Examples 18-24, wherein the physical interface is a wireless interface to a wireless protocol.

In Example 26, the subject matter of any of Examples 19-25 comprising: receiving a packet on the physical interface, the packet including a second identifier for a second device; searching for the second identifier among virtual interfaces of the ICN node; and disposing of the packet in response to failing to find the second identifier during the searching for the second identifier among the virtual interfaces.

In Example 27, the subject matter of Example 26, wherein searching for the second identifier among the virtual interfaces includes: providing the packet to each virtual interfaces for the physical interface; and matching the second identifier to a local identifier by each virtual interface, each virtual interface refraining from processing the packet in response to the second identifier not matching the local identifier.

In Example 28, the subject matter of any of Examples 18-27 comprising: detecting that the device is no longer available via the physical interface; and disabling the virtual interface.

In Example 29, the subject matter of Example 28, wherein disabling the virtual interface includes deleting the virtual interface.

In Example 30, the subject matter of Example 29, wherein disabling the virtual interface includes deleting entries in a pending interest table that correspond to the virtual interface.

In Example 31, the subject matter of any of Examples 29-30, wherein disabling the virtual interface includes deleting the FIB entry.

In Example 32, the subject matter of any of Examples 18-31, wherein the virtual interface is one of multiple virtual interfaces.

In Example 33, the subject matter of Example 32, wherein the multiple virtual interfaces include multiple types, each type corresponding to a number of potential devices.

In Example 34, the subject matter of Example 33, wherein the multiple types include unicast, broadcast, or multicast, wherein multicast is to more than one device and fewer than all devices.

Example 35 is at least one machine readable medium including instructions for device-specific connections in an information centric network (ICN), the instructions, when executed by processing circuitry, cause the processing circuitry to perform operations comprising: detecting, at an ICN node, a device on a physical interface; creating a virtual interface for the device on the physical interface; adding the virtual interface to a forward information base (FIB) entry; receiving an interest packet with a name that corresponds to the device; and forwarding the interest packet to the device through the physical interface using the virtual interface based on the FIB entry.

In Example 36, the subject matter of Example 35, wherein the virtual interface includes an identifier of the device.

In Example 37, the subject matter of Example 36, wherein forwarding the interest packet to the device through the physical interface using the virtual interface includes using the identifier in at least one of a physical layer, link layer, network layer, or transport layer for a protocol of the physical interface to unicast the interest packet to the device.

In Example 38, the subject matter of Example 37, wherein the identifier is a remote universal resource identifier (URI) of a transport layer to the physical interface.

In Example 39, the subject matter of Example 38, wherein the remote URI is immutable for the virtual interface after the virtual interface is created.

In Example 40, the subject matter of any of Examples 35-39, wherein the physical interface is a wired interface.

In Example 41, the subject matter of Example 40, wherein the wired interface is to a bus.

In Example 42, the subject matter of any of Examples 35-41, wherein the physical interface is a wireless interface to a wireless protocol.

In Example 43, the subject matter of any of Examples 36-42, wherein the operations comprise: receiving a packet on the physical interface, the packet including a second identifier for a second device; searching for the second identifier among virtual interfaces of the ICN node; and disposing of the packet in response to failing to find the second identifier during the searching for the second identifier among the virtual interfaces.

In Example 44, the subject matter of Example 43, wherein searching for the second identifier among the virtual interfaces includes: providing the packet to each virtual interfaces for the physical interface; and matching the second identifier to a local identifier by each virtual interface, each virtual interface refraining from processing the packet in response to the second identifier not matching the local identifier.

In Example 45, the subject matter of any of Examples 35-44, wherein the operations comprise: detecting that the device is no longer available via the physical interface; and disabling the virtual interface.

In Example 46, the subject matter of Example 45, wherein disabling the virtual interface includes deleting the virtual interface.

In Example 47, the subject matter of Example 46, wherein disabling the virtual interface includes deleting entries in a pending interest table that correspond to the virtual interface.

In Example 48, the subject matter of any of Examples 46-47, wherein disabling the virtual interface includes deleting the FIB entry.

In Example 49, the subject matter of any of Examples 35-48, wherein the virtual interface is one of multiple virtual interfaces.

In Example 50, the subject matter of Example 49, wherein the multiple virtual interfaces include multiple types, each type corresponding to a number of potential devices.

In Example 51, the subject matter of Example 50, wherein the multiple types include unicast, broadcast, or multicast, wherein multicast is to more than one device and fewer than all devices.

Example 52 is a system for device-specific connections in an information centric network (ICN), the system comprising: means for detecting, at an ICN node, a device on a physical interface; means for creating a virtual interface for the device on the physical interface; means for adding the virtual interface to a forward information base (FIB) entry; means for receiving an interest packet with a name that corresponds to the device; and means for forwarding the interest packet to the device through the physical interface using the virtual interface based on the FIB entry.

In Example 53, the subject matter of Example 52, wherein the virtual interface includes an identifier of the device.

In Example 54, the subject matter of Example 53, wherein the means for forwarding the interest packet to the device through the physical interface using the virtual interface include means for using the identifier in at least one of a physical layer, link layer, network layer, or transport layer for a protocol of the physical interface to unicast the interest packet to the device.

In Example 55, the subject matter of Example 54, wherein the identifier is a remote universal resource identifier (URI) of a transport layer to the physical interface.

In Example 56, the subject matter of Example 55, wherein the remote URI is immutable for the virtual interface after the virtual interface is created.

In Example 57, the subject matter of any of Examples 52-56, wherein the physical interface is a wired interface.

In Example 58, the subject matter of Example 57, wherein the wired interface is to a bus.

In Example 59, the subject matter of any of Examples 52-58, wherein the physical interface is a wireless interface to a wireless protocol.

In Example 60, the subject matter of any of Examples 53-59 comprising: means for receiving a packet on the physical interface, the packet including a second identifier for a second device; means for searching for the second identifier among virtual interfaces of the ICN node; and means for disposing of the packet in response to failing to find the second identifier during the searching for the second identifier among the virtual interfaces.

In Example 61, the subject matter of Example 60, wherein the means for searching for the second identifier among the virtual interfaces include: means for providing the packet to each virtual interfaces for the physical interface; and means for matching the second identifier to a local identifier by each virtual interface, each virtual interface refraining from processing the packet in response to the second identifier not matching the local identifier.

In Example 62, the subject matter of any of Examples 52-61 comprising: means for detecting that the device is no longer available via the physical interface; and means for disabling the virtual interface.

In Example 63, the subject matter of Example 62, wherein the means for disabling the virtual interface include means for deleting the virtual interface.

In Example 64, the subject matter of Example 63, wherein the means for disabling the virtual interface include means for deleting entries in a pending interest table that correspond to the virtual interface.

In Example 65, the subject matter of any of Examples 63-64, wherein the means for disabling the virtual interface include means for deleting the FIB entry.

In Example 66, the subject matter of any of Examples 52-65, wherein the virtual interface is one of multiple virtual interfaces.

In Example 67, the subject matter of Example 66, wherein the multiple virtual interfaces include multiple types, each type corresponding to a number of potential devices.

In Example 68, the subject matter of Example 67, wherein the multiple types include unicast, broadcast, or multicast, wherein multicast is to more than one device and fewer than all devices.

Example 69 is at least one machine-readable medium including instructions that, when executed by processing circuitry, cause the processing circuitry to perform operations to implement any of Examples 1-68.

Example 70 is an apparatus comprising means to implement any of Examples 1-68.

Example 71 is a system to implement any of Examples 1-68.

Example 72 is a method to implement any of Examples 1-68.

Example 73 is a system to deploy software to hardware in an edge network to configure the hardware to implement any of Examples 1-68.

Example 74 is a system to receive software from a deployment to edge hardware and run the software to configure the edge hardware to implement any of Examples 1-68.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B.” “B but not A,” and “A and B.” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first.” “second.” and “third.” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1.-24. (canceled)

25. An apparatus for device-specific connections in an information centric network (ICN), the apparatus comprising:
a connection to a physical interface;
a memory including instructions;
processing circuitry that, when in operation, is configured by the instructions to:
detect, via the connection to the physical interface, a device on the physical interface;
create a virtual interface for the device on the physical interface;
add the virtual interface to a forward information base (FIB) entry;
receive an interest packet with a name that corresponds to the device; and
forward the interest packet to the device through the physical interface using the virtual interface based on the FIB entry, wherein the apparatus is included in an ICN node.

26. The apparatus of claim 25, wherein the virtual interface includes an identifier of the device.

27. The apparatus of claim 26, wherein, to forward the interest packet to the device through the physical interface using the virtual interface, the processing circuitry uses the identifier in at least one of a physical layer, link layer, network layer, or transport layer for a protocol of the physical interface to unicast the interest packet to the device.

28. The apparatus of claim 27, wherein the identifier is a remote universal resource identifier (URI) of a transport layer to the physical interface.

29. The apparatus of claim 26, wherein the instructions configure the processing circuitry to:
receive a packet on the physical interface, the packet including a second identifier for a second device;
search for the second identifier among virtual interfaces of the ICN node; and
dispose of the packet in response to failing to find the second identifier during the searching for the second identifier among the virtual interfaces.

30. The apparatus of claim 29, wherein, to search for the second identifier among the virtual interfaces, the processing circuitry is configured by the instructions to:
provide the packet to each virtual interfaces for the physical interface; and
match the second identifier to a local identifier by each virtual interface, each virtual interface refraining from processing the packet in response to the second identifier not matching the local identifier.

31. The apparatus of claim 25, wherein the instructions configure the processing circuitry to:
detect that the device is no longer available via the physical interface; and
disable the virtual interface.

32. The apparatus of claim 25, wherein the virtual interface is one of multiple virtual interfaces.

33. A method for device-specific connections in an information centric network (ICN), the method comprising:
detecting, at an ICN node, a device on a physical interface;
creating a virtual interface for the device on the physical interface;
adding the virtual interface to a forward information base (FIB) entry;
receiving an interest packet with a name that corresponds to the device; and
forwarding the interest packet to the device through the physical interface using the virtual interface based on the FIB entry.

34. The method of claim 33, wherein the virtual interface includes an identifier of the device.

35. The method of claim 34, wherein forwarding the interest packet to the device through the physical interface using the virtual interface includes using the identifier in at least one of a physical layer, link layer, network layer, or transport layer for a protocol of the physical interface to unicast the interest packet to the device.

36. The method of claim 35, wherein the identifier is a remote universal resource identifier (URI) of a transport layer to the physical interface.

37. The method of claim 34 comprising:
receiving a packet on the physical interface, the packet including a second identifier for a second device;
searching for the second identifier among virtual interfaces of the ICN node; and
disposing of the packet in response to failing to find the second identifier during the searching for the second identifier among the virtual interfaces.

38. The method of claim 37, wherein searching for the second identifier among the virtual interfaces includes:
providing the packet to each virtual interfaces for the physical interface; and
matching the second identifier to a local identifier by each virtual interface, each virtual interface refraining from processing the packet in response to the second identifier not matching the local identifier.

39. The method of claim 33 comprising:
detecting that the device is no longer available via the physical interface; and
disabling the virtual interface.

40. The method of claim 33, wherein the virtual interface is one of multiple virtual interfaces.

41. At least one non-transitory machine readable medium including instructions for device-specific connections in an information centric network (ICN), the instructions, when executed by processing circuitry, cause the processing circuitry to perform operations comprising:
detecting, at an ICN node, a device on a physical interface;
creating a virtual interface for the device on the physical interface;
adding the virtual interface to a forward information base (FIB) entry;
receiving an interest packet with a name that corresponds to the device; and
forwarding the interest packet to the device through the physical interface using the virtual interface based on the FIB entry.

42. The at least one non-transitory machine readable medium of claim 41, wherein the virtual interface includes an identifier of the device.

43. The at least one non-transitory machine readable medium of claim 42, wherein forwarding the interest packet to the device through the physical interface using the virtual interface includes using the identifier in at least one of a physical layer, link layer, network layer, or transport layer for a protocol of the physical interface to unicast the interest packet to the device.

44. The at least one non-transitory machine readable medium of claim 43, wherein the identifier is a remote universal resource identifier (URI) of a transport layer to the physical interface.

45. The at least one non-transitory machine readable medium of claim 42, wherein the operations comprise:
receiving a packet on the physical interface, the packet including a second identifier for a second device;
searching for the second identifier among virtual interfaces of the ICN node; and
disposing of the packet in response to failing to find the second identifier during the searching for the second identifier among the virtual interfaces.

46. The at least one non-transitory machine readable medium of claim 45, wherein searching for the second identifier among the virtual interfaces includes:
providing the packet to each virtual interfaces for the physical interface; and
matching the second identifier to a local identifier by each virtual interface, each virtual interface refraining from processing the packet in response to the second identifier not matching the local identifier.

47. The at least one non-transitory machine readable medium of claim 41, wherein the operations comprise:
detecting that the device is no longer available via the physical interface; and
disabling the virtual interface.

48. The at least one non-transitory machine readable medium of claim 41, wherein the virtual interface is one of multiple virtual interfaces.
